(19) United States
(12) Patent Application Publication
(10) Pub. No.: US 2004/0089086 A1
(43) Pub. Date: May 13, 2004

(54) Transmission having rigid link between shafts

(76) Inventors: Gregory A. Ewing, Lee's Summit, MO (US); Donald R. Heskett JR., Centerview, MO (US); Michael A. Van Haele, Blue Springs, MO (US); Thomas L. Buzze, Maiden, NC (US); Ivan E. Bounds, Lake Havasu City, AZ (US)

Correspondence Address: SHOOK, HARDY & BACON LLP, 2555 GRAND BLVD, KANSAS CITY,, MO, 64108, US

(21) Appl. No.: 10/292,309

(22) Filed: Nov. 12, 2002

(51) Int. Cl. F16H 3/091

(52) U.S. Cl. 74/325

(57) ABSTRACT

A transmission for an automotive vehicle or other machine has an input shaft carrying an input gear that mates with and drives a reduction gear carried on a countershaft. The countershaft carries a plurality of drive gears that mesh with driven gears on an output shaft. A rigid link is connected between the output shaft and countershaft to prevent the shafts from flexing relative to one another and thereby cause improper meshing of the gears. The link can also be rigidly connected with the transmission housing or a cast part of housing to keep the shafts from flexing relative to the housing.

### FIELD OF THE INVENTION

This invention relates generally to the transmission of power between shafts and more particularly to a transmission in which a rigid link serves to connect the shafts in order to prevent them from flexing relative to one another.

### BACKGROUND OF THE INVENTION

In automotive vehicles and a variety of other applications, power is transmitted between an input shaft and an output shaft by means of a transmission mechanism. For example, high performance vehicles such as race cars have transmissions that typically include a gear train in which a countershaft carries gears that are driven by the input shaft that is in turn driven by the engine. It is common for the input shaft to carry an input gear that mates with and drives a gear on the countershaft. Drive gears on the countershaft mate with driven gears on the output shaft. A shift mechanism selectively engages the driven gears with the output shaft in order to drive it in accordance with the selected gear ratio. An example of a transmission of this type is disclosed in U.S. Pat. No. 5,816,101 to Weston.

For the most part, this type of transmission has provided acceptable service in race cars and other applications where high performance operation is critical. However, such transmissions have not been wholly free of problems. In order to achieve the highest efficiency in the transmission of power between gears, it is essential for the teeth of the gears to mesh exactly. Otherwise, there are mechanical losses that detract from the energy efficiency and performance of the vehicle.

One problem with prior transmissions is that the input and output shafts can flex to some extent relative to the countershaft. When the shafts flex away from each other, the gears they carry do not mesh exactly, and the imperfect meshing of the gears results in mechanical losses and reduced deficiency in transmitting power. It also creates increased wear on the gear teeth which can lead to further mechanical losses and even failure in extreme cases. Any flexing of the shafts relative to the case of the transmission also detract from the precision of the meshing of the gears and creates inefficiencies for this reason.

### SUMMARY OF THE INVENTION

It is the primary goal of the present invention to provide a transmission in which the input and output shafts are rigidly tied to the countershaft so that the shafts are restrained from flexing toward and away from one another within the transmission case. A further object of the invention is to provide a transmission in which both shafts or one of the shafts are restrained from flexing relative to the transmission case.

These and other objects and features of the invention are achieved by installing a rigid link that connects the countershaft with the input and output shafts in a manner to restrain both shafts or either one of the shafts against relative flexure. This keeps the mating gears in the proper meshing contact so that power is transferred between the shafts with maximum efficiency. The link has a bearing connection with the countershaft and output shaft so that all of the shafts are able to freely turn.

It is another important feature of the invention that the connecting link can be rigidly secured to the transmission case or a cast part of the case. As a result, none of the shafts can flex significantly relative to the case, and possible inefficiency due to shaft flexure is avoided. The link can be connected with the transmission case by any suitable means such as by rigid bars connecting the link with the front and back walls of the case. This fixes the link in place against movement and in turn keeps the shafts from moving in the case in a way that could allow the gears to mesh improperly.

### DESCRIPTION OF THE DRAWINGS

In the accompanying drawings which form a part of the specification and are to be read in conjunction therewith and in which like reference numerals are used to indicate like parts in the various views:

FIG. 1 is a front elevational view of a transmission constructed according to a preferred embodiment of the present invention, with a portion of the housing of the transmission broken away to show internal details;

FIG. 2 is a top plan view of the transmission shown in FIG. 1, with a portion of the housing broken away;

FIG. 3 is a sectional view on an enlarged scale taken generally along line 3-3 of FIG. 1 in the direction of the arrows;

FIG. 4 is an elevational view of the rigid link which is included in the transmission in accordance with a preferred embodiment of the invention; and

FIG. 5 is a sectional view on an enlarged scale taken generally along line 5-5 of FIG. 4 in the direction of the arrows.

### DETAILED DESCRIPTION OF THE INVENTION

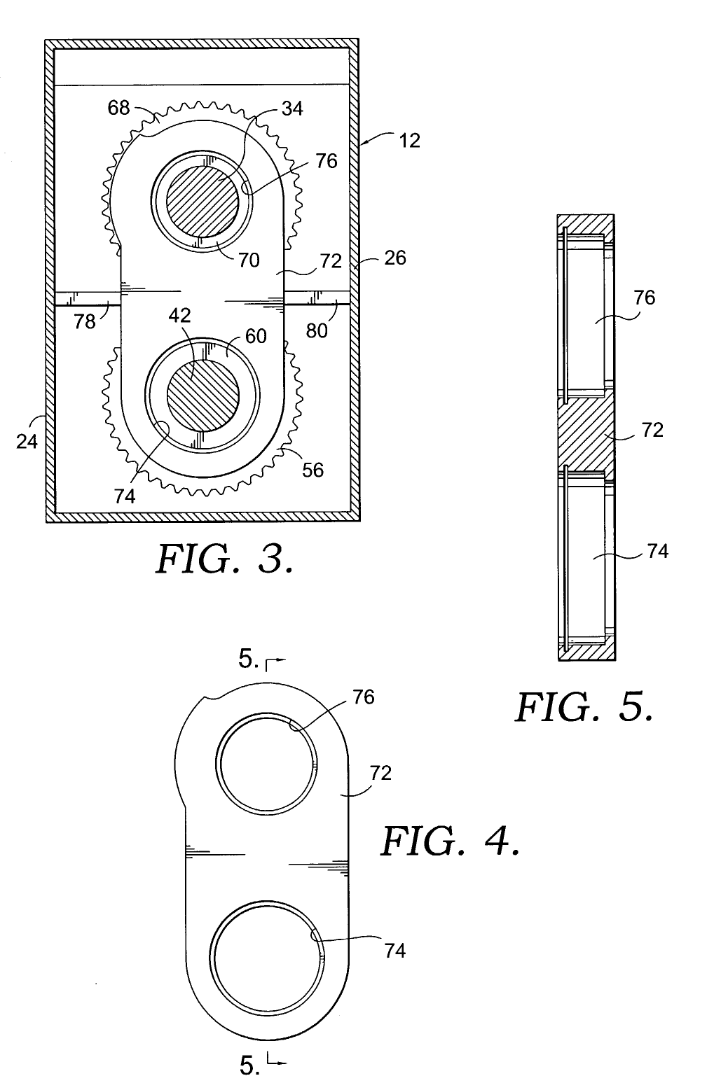

Referring now to the drawings in more detail, numeral 10 generally designates a transmission constructed in accordance with a preferred embodiment of the present invention. The transmission 10 includes a casing or housing 12 in which the operating components are contained and supported. The housing 12 includes an end wall 14 on the input end and another end wall 16 on the output end. An extension 18 of the housing is provided with a flange 20 which is bolted at 22 to the end wall 16 or end plate. As best shown in FIGS. 2 and 3, the housing 12 further includes a front wall 24 and a back wall 26. Transmission fluid is typically contained within the housing 12.

An input shaft 28 extends into the housing 12 and is supported for rotation by a bearing 30 mounted on the end wall 14. The input shaft 28 is driven rotatively by the engine of an automotive vehicle or other apparatus. Inside of the housing 12, the input shaft carries and drives an input gear 32.

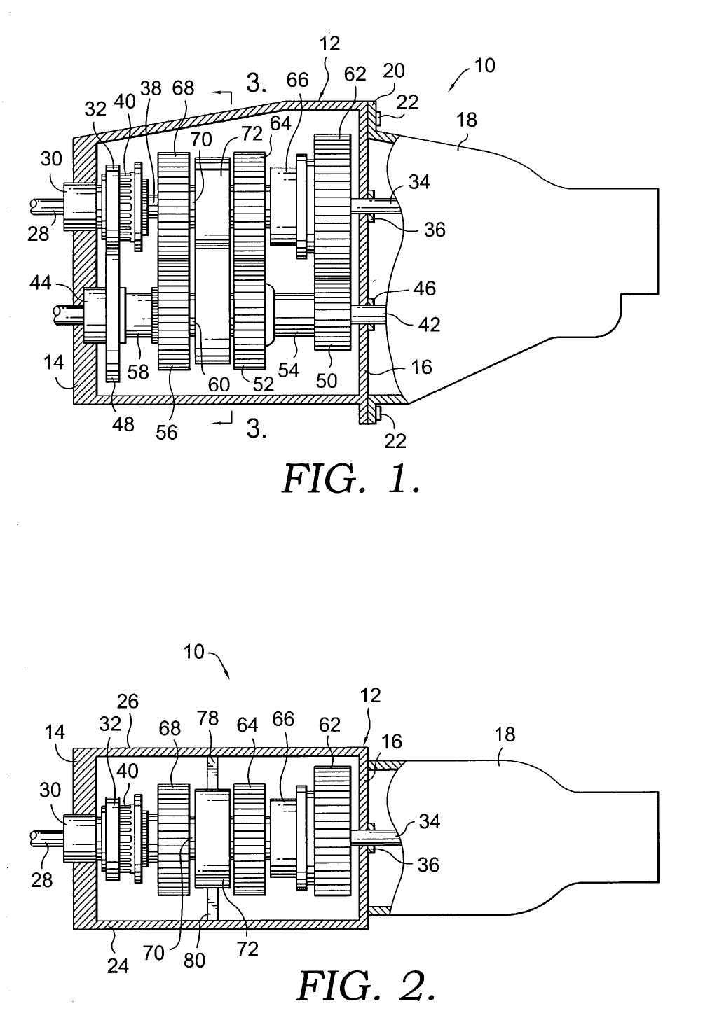

The input shaft 28 is located end to end with and in line with an output shaft 34 which extends through the end wall or end plate 16. A bearing 36 mounted on wall 16 supports shaft 34 for rotation. Another bearing 38 (FIG. 1) connects the input and output shafts 28 and 34 end to end while allowing them to rotate relative to one another.

The transmission 10 further includes a countershaft 42 which is spaced below and parallel to the shafts 28 and 34. One end of the countershaft 42 is supported for rotation by a bearing 44 mounted on the end wall 14. The opposite end portion of the countershaft 42 is supported for rotation by a bearing 46 mounted on the opposite end wall 16.

The countershaft 42 carries near one end a gear 48 that mates with and is driven by the input gear 32.

Near its opposite or right end, the countershaft 42 carries a drive gear 50 which is a relatively small gear that is used to effect a low gear condition of the transmission. A larger gear 52 is also carried on shaft 42 and is spaced from gear 50. Gear 52 is larger than gear 50 and may be used to effect a second gear condition of the transmission. Another drive gear 56 is mounted on the countershaft 42. Gear 56 is spaced from gear 48. Gear 56 is larger than gear 52 and may be used to effect a third gear condition of the transmission. Additional drive gears (not shown) may be mounted on the countershaft 42 in order to provide a larger number of different gear ratios if desired.

The output shaft 34 is provided with a driven gear 62 that mates with gear 50. Gear 62 may be somewhat larger than gear 50. Another driven gear 64 is mounted on the output shaft 34 and is spaced from gear 62. Gear 64 mates with the second drive gear 52. A third driven gear 68 is located on the output shaft 34. Gear 38 mates with and is driven by gear 56. A bearing 70 is located on shaft 34 between gears 64 and 68.

In operation of the transmission, a conventional shift mechanism (not shown) is used to engage a selected one of the gears 62, 64 or 68 with the output shaft 34 in order to rotate the output shaft at a gear ratio that is dependent upon which of the gears 62, 64 or 68 is engaged with the output shaft. In this manner, the output shaft 34 is driven by the input shaft 28 (through the countershaft 42) in either a first gear, second gear, or third gear setting. As previously indicated, additional drive and driven gears can be provided on the countershaft 42 and output shaft 34 in order to provide more mating gear sets if desired.

A suitable mechanism is provided in accordance with conventional practice to provide a reverse direction for the transmission. The output shaft 42 connects in a suitable fashion with the output device which may be a differential or transaxle (not shown) used to drive the wheels of an automotive vehicle or other apparatus that makes use of the transmission 10.

In accordance with the present invention, a rigid link 72 is provided to connect the in line shaft assembly made up of the input shaft 28 and the output shaft 34 with the countershaft 42 in order to prevent the input and output shafts from flexing toward or away from the countershaft 42. Such flexing is undesirable because it results in imperfect meshing between the drive gears on the countershaft and the driven gears on the output shaft, thereby creating mechanical losses and inefficient power transmission, as well as undue wear on the teeth of the gears. The link may be constructed of a metal such as steel or any other suitable material.

As best shown in FIGS. 3-5, the link 72 is provided near its lower end with a circular passage 74 which receives the lower bearing 60 of the countershaft 42. The countershaft 42 in turn is fitted to extend through the bearing 60. By reason of this bearing connection between the link 72 and the countershaft 42, the countershaft is able to rotate freely relative to the stationary link.

The upper portion of the link 72 is provided with another circular passage 76 that receives the upper bearing 70 of the output shaft 34. The output shaft 34 extends through the bearing 70. By reason of this bearing connection between the link 72 and the output shaft 34, the output shaft is able to rotate relative to the stationary link.

The end to end connection of the input shaft 28 and output shaft 34 and the bearing connection 38 between them maintains shafts 28 and 34 in line with one another. The countershaft 42 is located below and parallel to shafts 28 and 34. By reason of the connection between the shafts provided by the link 72, the input and output shafts 28 and 34 and the countershaft 42 are not able to flex toward and away from one another. Thus, the link 72 prevents relative flexure of the shafts and maintains the gears that are on the shafts in proper meshing relationship to prevent mechanical losses and inefficiencies that could otherwise occur due to imperfect meshing of the gear sets.

In accordance with the present invention, the link 72 can also connected rigidly with the transmission housing 12. As shown in FIGS. 2 and 3, this can be accomplished by a rigid strut or bar 78 that is connected with the front edge of the link 72 and connected with or cast as part of the front housing wall 24 near its center. Another rigid strut or bar 80 can be used to connect the rear edge of the link 72 with the back wall 26 of the transmission housing 12. The bars 78 and 80 can be connected with the link and the transmission housing by any suitable means such as by welding. It should be understood that other ways of rigidly connecting the link 72 with the transmission housing can be used and that the bars 78 and 80 are only examples of a presently preferred way of connecting the link with the transmission housing.

The rigid connection of the link 72 to the transmission housing 12 provides assurance that the shafts 28, 34 and 42 do not flex relative to the housing 12. The provides additional assurance that the drive and driven gears will not imperfectly mesh, as all of the shafts are held stationary relative to the housing by the link 72 and the connections provided by the bars 78 and 80.

What is claimed is:

1. A transmission comprising:
a transmission housing;
a drive train shaft assembly including an input shaft and an output shaft supported by said housing for rotation in line with one another;
an input gear on said input shaft;
a plurality of drive gears on said output shaft;
a countershaft supported by said housing for rotation, said countershaft being spaced from and substantially parallel to said shaft assembly;
a gear on said countershaft mating with and driven by said input gear;
a plurality of drive gears on said countershaft mating selectively with said driven gears to drive said output shaft; and
a rigid link connecting said shaft assembly and said countershaft in a manner to substantially prevent relative flexure of said shaft assembly and countershaft toward and away from one another.

2. A transmission as set forth in claim 1, wherein:
said input and output shafts are connected end to end; and
said link connects said output shaft and said countershaft.

3. A transmission as set forth in claim 2, wherein said link is rigidly connected with said housing.

4. A transmission as set forth in claim 1, wherein said link is rigidly connected with said housing.

5. A transmission as set forth in claim 1, including:
a bearing connection between said shaft assembly and link allowing said shaft assembly to rotate relative to said link; and
a bearing connection between said countershaft and link allowing said countershaft to rotate relative to said link.

6. A transmission as set forth in claim 5, wherein said link is rigidly connected with said housing.

7. A transmission comprising:
a transmission housing;
an input shaft supported by said housing for rotation and carrying an input gear;
a countershaft supported by said housing for rotation and carrying a reduction gear mating with and driven by said input gear;
a plurality of drive gears on said countershaft;
an output shaft supported by said housing for rotation and carrying a plurality of driven gears mating selectively with said drive gears for driving of said output shaft; and
a rigid link connecting said output shaft and said countershaft in a manner to substantially prevent relative flexure of said output shaft and countershaft toward and away from one another.

8. A transmission as set forth in claim 7, wherein said link is rigidly connected with said housing.

9. A transmission as set forth in claim 7, wherein:
said countershaft is located below and substantially parallel to said output shaft;
said housing has a front and a back; and
said link is rigidly connected with said front and said back.

10. A transmission as set forth in claim 7, including:
a bearing connection between said output shaft and link allowing said output shaft to rotate relative to said link; and
a bearing connection between said countershaft and link allowing said countershaft to rotate relative to said link.

11. A transmission as set forth in claim 10, wherein said link is rigidly connected with said housing.

12. A transmission as set forth in claim 10, wherein:
said countershaft is located below and substantially parallel to said output shaft;
said housing has a front and a back; and
said link is rigidly connected with said front and said back.

13. A transmission comprising:
a transmission housing;
an input shaft supported by said housing for rotation;
an input gear on said input shaft at a location within said housing;
an output shaft supported by said housing for rotation end to end and in line with said input shaft;
a plurality of driven gears on said output shaft;
a countershaft supported by said housing for rotation at a location spaced from and substantially parallel to said input and output shafts;
a plurality of drive gears on said countershaft mating selectively with said driven gears to drive said output shaft; and
a rigid link connecting said output shaft and countershaft in a manner to substantially prevent relative flexure therebetween, said link being rigidly connected with said housing to substantially prevent said output shaft and countershaft from flexing relative to said housing.

14. A transmission as set forth in claim 13, including:
a bearing connection between said output shaft and link allowing said output shaft to rotate relative to said link; and
a bearing connection between said countershaft and link allowing said countershaft to rotate relative to said link.

15. A transmission as set forth in claim 14, wherein:
said countershaft is located below said output shaft;
said housing has a front and a back; and
said link is rigidly connected with said front and said back.

16. A transmission as set forth in claim 13, wherein:
said countershaft is located below said output shaft;
said housing has a front and a back; and
said link is rigidly connected with said front and said back.
